(19) United States
(12) Patent Application Publication
(10) Pub. No.: US 2007/0052625 A1
(43) Pub. Date: Mar. 8, 2007

(54) Plasma display apparatus and method of driving the same

(75) Inventor: Ji-seung Yoo, Yongin-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/514,169

(22) Filed: Sep. 1, 2006

(30) Foreign Application Priority Data
Sep. 6, 2005 (KR) 10-2005-0082928

(51) Int. Cl. G09G 3/28

(52) U.S. Cl. 345/67

(57) ABSTRACT

A plasma display apparatus and a method of driving the same are disclosed. When the plasma display apparatus is driven by dividing a frame into a plurality of subfields, a portion of all scan electrodes is scanned during an address period of at least one of the plurality of subfields.

This Nonprovisional application claims priority under 35 U.S.C. § 119(a) on Patent Application No. 10-2005-0082928 filed in Korea on Sep. 6, 2005 the entire contents of which are hereby incorporated by reference.

### BACKGROUND OF THE INVENTION

1. Field of the Invention

This document relates to a plasma display apparatus and a method of driving the same.

2. Description of the Background Art

A plasma display apparatus comprises a plasma display panel on which an image is displayed and a driver for driving the plasma display panel.

The plasma display panel comprises a phosphor formed within a discharge cell partitioned by a barrier rib and a plurality of electrodes through which a driving signal is supplied to the discharge cell.

When the driving signal is supplied to the discharge cell, a discharge gas filled in the discharge cell generates vacuum ultraviolet rays. The vacuum ultraviolet rays excite the phosphor formed within the discharge cell such that an image is displayed on the plasma display panel.

A method for representing gray level of an image of a related art plasma display apparatus is illustrated in FIG. 1.

As illustrated in FIG. 1, in the method for representing gray level of an image of a related art plasma display apparatus, a frame is divided into several subfields having a different number of emission times. Each of the subfields is subdivided into a reset period for initializing all the cells, an address period for selecting cells to be discharged and a sustain period for representing gray level according to the number of discharges.

For example, if an image with 256 gray level is to be displayed, a frame period (for example, 16.67 ms) corresponding to 1/60 sec is divided into eight subfields SF1 to SF8. Each of the eight subfields SF1 to SF8 is subdivided into a reset period, an address period and a sustain period.

The duration of the reset period in a subfield is equal to the duration of the reset periods in the remaining subfields. The duration of the address period in a subfield is equal to the duration of the address periods in the remaining subfields. The voltage difference between an address electrode and a transparent electrode, which is a scan electrode, generates an address discharge for selecting the cells to be discharged. The sustain period increases in a ratio of 2ⁿ (where, n=0, 1, 2, 3, 4, 5, 6, 7) in each of the subfields. Since the sustain period varies from one subfield to the next subfield, a specific gray level is achieved by controlling the sustain period which are to be used for discharging each of the selected cells, i.e., the number of sustain discharges that are realized in each of the discharge cells.

In the related art plasma display apparatus, a scan pulse is supplied to all the scan electrodes during the address period of each subfield, and at the same time, a data pulse is supplied to the address electrode such that a cell to be discharged is selected. In other words, all the scan electrode lines of the plasma display apparatus are scanned.

Since all the scan electrodes are scanned within a limited duration of time of a frame (i.e., during an address period), it is difficult to improve brightness by increasing the sustain period. In particular, as a demand for a high-definition and large-sized plasma display panel has been increased, the number of scan electrode lines increases. As a result, the time required in the scanning of the scan electrode lines lengthens such that the brightness of the plasma display apparatus is not sufficient within the limited duration of time of the frame.

### SUMMARY OF THE INVENTION

Accordingly, an object of the present invention is to solve at least the problems and disadvantages of the background art.

An embodiment of the present invention provides a plasma display apparatus and a method of driving the same capable of driving at high speed through a reduction in the addressing time by improving a method of driving a plasma display panel.

The embodiment of the present invention also provides a plasma display apparatus and a method of driving the same capable of simultaneously performing both a reduction in the addressing time and the maintenance of a brightness characteristic.

In an aspect, there is provided a method of driving a plasma display apparatus, which is driven by dividing a frame into a plurality of subfields, comprising scanning a portion of all scan electrodes during an address period of at least one subfield of the plurality of subfields.

Implementations may include one or more of the following features. All the scan electrodes may be divided into a predetermined number of scan electrode groups, and a portion of the predetermined number of scan electrode groups may be scanned.

The number of scan electrodes belonging to each of the predetermined number of scan electrode groups may be equal to one another.

The number of scan electrodes belonging to at least one of the predetermined number of scan electrode groups may be different from the number of scan electrodes belonging to the remaining scan electrode groups.

Odd-numbered scan electrodes or even-numbered scan electrodes of all the scan electrodes may be scanned.

At least one subfield of the plurality of subfields may be a subfield with gray level weight equal to or less than critical gray level weight.

The subfield with gray level weight equal to or less than the critical gray level weight may comprise three low gray level subfields.

In another aspect, there is provided a method of driving a plasma display apparatus, which is driven by dividing a frame into a plurality of subfields, comprising scanning odd-numbered scan electrodes or even-numbered scan electrodes of all scan electrodes during an address period of each of odd-numbered subfields of the plurality of subfields, and scanning scan electrodes different from the scan electrodes, that are scanned during the address period of each of the odd-numbered subfields, during an address period of each of even-numbered subfields of the plurality of subfields.

In still another aspect, there is provided a plasma display apparatus comprising a plasma display panel comprising a plurality of scan electrodes, a scan driver for supplying a scan pulse to the plurality of scan electrode, and a timing controller for controlling the scan driver to supply the scan pulse to a portion of the plurality of scan electrode during an address period of at least one subfield of a plurality of subfields.

It is to be understood that both the foregoing general description and the following detailed description are exemplary and explanatory and are intended to provide further explanation of the invention as claimed.

### BRIEF DESCRIPTION OF THE DRAWINGS

The invention will be described in detail with reference to the following drawings in which like numerals refer to like elements.

FIG. 1 illustrates a method for representing gray level of an image of a related art plasma display apparatus;

FIG. 2 illustrates a plasma display apparatus according to a first embodiment of the present invention;

FIG. 3 illustrates a method of driving the plasma display apparatus according to the first embodiment of the present invention;

FIGS. 4a to 4c illustrate a scanning method of a scan driver of a plasma display apparatus according to a second embodiment of the present invention; and

FIG. 5 illustrates a method of driving the plasma display apparatus according to the second embodiment of the present invention.

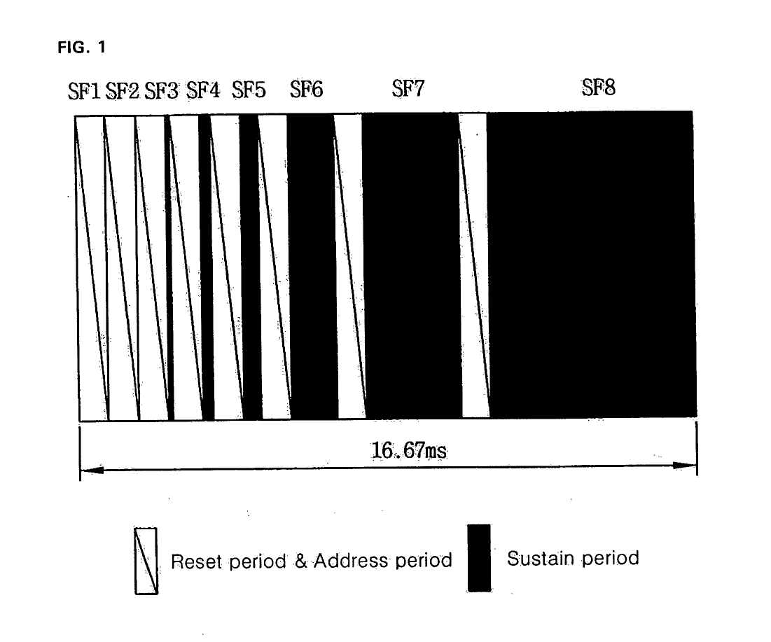

### DETAILED DESCRIPTION OF PREFERRED EMBODIMENTS

Preferred embodiments of the present invention will be described in a more detailed manner with reference to the drawings.

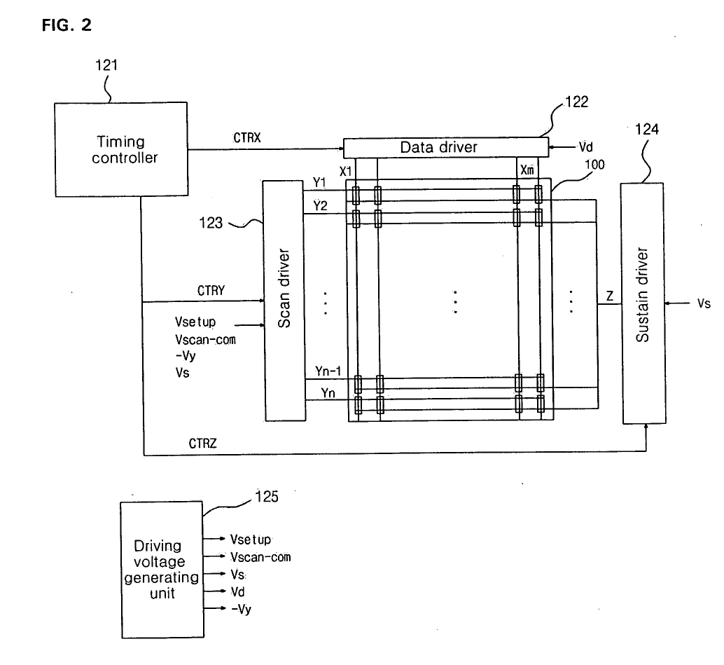

FIG. 2 illustrates a plasma display apparatus according to a first embodiment of the present invention.

As illustrated in FIG. 2, a plasma display apparatus according to a first embodiment of the present invention comprises a plasma display panel 100 comprising scan electrodes Y1 to Yn, sustain electrodes Z and address electrodes X1 to Xm intersecting the scan electrodes Y1 to Yn and the sustain electrodes Z, a data driver 122, a scan driver 123, a sustain driver 124, a timing controller 121 and a driving voltage generator 125. The data driver 122 supplies data to the address electrodes X1 to Xm formed on a lower substrate (not shown) of the plasma display panel 100. The scan driver 123 drives scan electrodes Y1 to Yn and the sustain driver 124 drives sustain electrodes Z being common electrodes. The timing controller 121 controls the data driver 122, the scan driver 123 and the sustain driver 124 when driving the plasma display panel 100. The driving voltage generating unit 125 supplies a necessary driving voltage to each of the drivers 122, 123 and 124.

The plasma display apparatus of the above-described structure according to the first embodiment of the present invention displays an image due to combination of at least one subfield of a frame during which a driving pulse is supplied to the scan electrodes Y1 to Yn, the sustain electrodes Z and the address electrodes X1 to Xm.

An upper substrate (not shown) and the lower substrate of the plasma display panel 100 are coalesced with each other at a given distance. On the upper substrate, a plurality of electrodes, for example, the scan electrodes Y1 to Yn and the sustain electrodes Z are formed in pairs. On the lower substrate, the address electrodes X1 to Xm are formed to intersect the scan electrodes Y1 to Yn and the sustain electrodes Z.

The data driver 122 receives data mapped in each subfield by a subfield mapping circuit (not shown) after being inverse-gamma corrected and error-diffused through an inverse gamma correction circuit (not shown) and an error diffusion circuit (not shown), or the like. The data driver 122 samples and latches the mapped data in response to a timing control signal CTRX supplied from the timing controller 121, and then the data to the address electrodes X1 to Xm.

Under the control of the timing controller 121, the scan driver 123 supplies a scan pulse of a scan voltage −Vy to the scan electrodes during an address period. More specifically, the scan driver 123, under the control of the timing controller 121, does not supply sequentially the scan pulse to all the scan electrodes Y1 to Yn, and sequentially supplies the scan pulse to a portion of all the scan electrodes Y1 to Yn in at least one subfield of a plurality of subfields of a frame. For example, the scan pulse is supplied to the odd-numbered scan electrodes Y1, Y3, Y5, . . . , and the odd-numbered scan electrodes Y1, Y3, Y5, . . . are scanned. Otherwise, the scan pulse is supplied to the even-numbered scan electrodes Y2, Y4, Y6, . . . , and the even-numbered scan electrodes Y2, Y4, Y6, . . . are scanned. Further, the scan driver 123 supplies a sustain pulse to the scan electrodes Y1 to Yn during a sustain period.

Under the control of the timing controller 121, the sustain driver 124 supplies a predetermined bias voltage to the sustain electrodes Z during a set-down period of the reset period and the address period. The sustain driver 124 supplies a sustain pulse to the sustain electrodes Z during the sustain period. The scan driver 123 and the sustain driver 124 operate alternately with each other during the sustain period.

The timing controller 121 receives a vertical/horizontal synchronization signal and a clock signal, and generates timing control signals CTRX, CTRY and CTRZ for controlling the operation timing and synchronization of each driver 122, 123 and 124. The timing controller 121 supplies the timing control signals CTRX, CTRY and CTRZ to the corresponding drivers 122, 123 and 124 to control each of the drivers 122, 123 and 124.

The data control signal CTRX includes a sampling clock for sampling data, a latch control signal, and a switch control signal for controlling the on/off time of an energy recovery circuit and driving switch elements inside the data driver 122. The scan control signal CTRY includes a switch control signal for controlling the on/off time of an energy recovery circuit and driving switch elements inside the scan driver 123. The sustain control signal CTRZ includes a switch control signal for controlling the on/off time of an energy recovery circuit and driving switch elements inside the sustain driver 124.

The driving voltage generating unit 125 generates driving voltages such as a setup voltage Vsetup, a scan common voltage Vscan-com, a scan voltage −Vy, a sustain voltage Vs, a data voltage Vd. These driving voltages may vary in accordance with the composition of the discharge gas or the structure of the discharge cells.

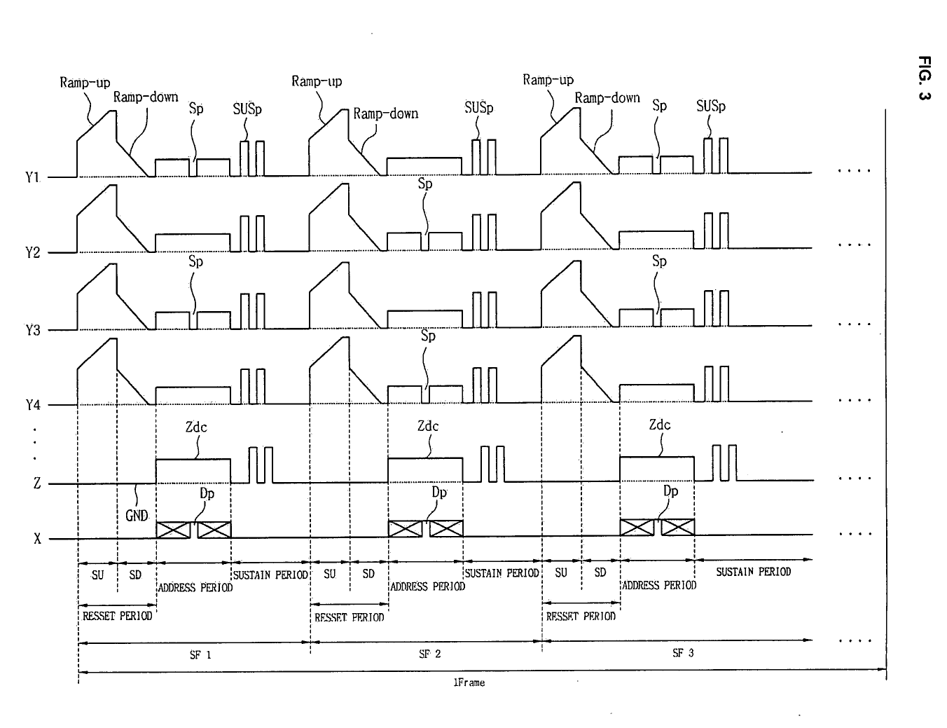

FIG. 3 illustrates a method of driving the plasma display apparatus according to the first embodiment of the present invention.

Referring to FIG. 3, the plasma display apparatus according to the first embodiment of the present invention is driven by dividing a frame into a plurality of subfields SF1, SF2, SF3, . . . . Each subfield is divided into a reset period, an address period and a sustain period. More specifically, during an address period of any one of the plurality of subfields, a portion of the scan electrode lines may be scanned. In FIG. 3, a portion of the scan electrode lines is scanned during the address period of each subfield.

In other words, a portion of all the scan electrode lines is scanned during an address period of at least one of the plurality of subfields. Such a driving method is called a partial line addressing (PLA) method in the embodiment of the present invention. The method of driving the plasma display apparatus using the PLA method in each subfield will be described in detail below.

<First Subfield>

A reset period of a first subfield SF1 is divided into a setup period SU and a set-down period SD. During the setup period SU, a rising waveform (Ramp-up) is simultaneously supplied to all the scan electrode lines Y1 to Yn. During the set-down period SD, a falling waveform (Ramp-down) which falls from a voltage lower than a peak voltage of the rising waveform (Ramp-up) to a given voltage is simultaneously supplied to all the scan electrode lines Y1 to Yn. This results in the remaining wall charges being uniform within the cells.

Although the rising waveform and the falling waveform are supplied during the setup period and the set-down period, any waveform for making the remaining wall charges uniform within the cells may be supplied to the scan electrode lines. Further, the reset period does not need to comprise the setup period and the set-down period. The reset period may comprise any period for making the remaining wall charges uniform within the cells. For example, the reset period may consist of the setup period or may consist of the set-down period.

During an address period, a scan pulse Sp is not supplied to all the scan electrode lines Y1 to Yn, and the scan pulse Sp is supplied to a portion of all the scan electrode lines Y1 to Yn. For example, a scan pulse Sp is supplied to odd-numbered scan electrode lines Y1, Y3, Y5, . . . of all the scan electrode lines Y1 to Yn. At this time, a data pulse Dp synchronized with the scan pulse Sp is supplied to the address electrodes X. As the voltage difference between the scan pulse Sp and the data pulse Dp is added to the wall voltage generated during the reset period, an address discharge is generated within the discharge cells to which the data pulse is supplied.

In FIG. 3, the scan pulse Sp is supplied to the odd-numbered scan electrode lines Y1, Y3, Y5, . . . of all the scan electrode lines Y1 to Yn. However, the scan pulse Sp may be supplied to even-numbered scan electrode lines Y2, Y4, Y6, . . . of all the scan electrode lines Y1 to Yn such that an address discharge may be generated within the discharge cells to which the data pulse is supplied. Wall charges are formed inside the cells selected by performing the address discharge such that when a sustain voltage Vs is applied a discharge occurs.

A positive voltage Zdc is supplied to the sustain electrodes Z during the set-down period and the address period so that an erroneous discharge does not occur between the sustain electrode and the scan electrode by reducing the voltage difference between the sustain electrode Z and the scan electrode Y. Preferably, as illustrated in FIG. 3, a given voltage (for example, a ground level voltage) less than the positive voltage Zdc is supplied to the sustain electrodes Z during the set-down period, and the positive voltage Zdc is supplied to the sustain electrodes Z during the address period. A jitter characteristic generated by performing the address discharge is improved by supplying the given voltage less than the positive voltage Zdc to the sustain electrodes Z such that the addressing time is further reduced.

During the sustain period, a sustain pulse SUSp is alternately supplied to the scan electrode and the sustain electrode. As the wall voltage within the cells selected by performing the address discharge is added to the sustain pulse SUSp, every time the sustain pulse SUSp is applied, a sustain discharge, i.e., a display discharge is generated in the cells selected during the address period.

After the sustain discharge is completed, an erase period may be included in each subfield in accordance with a discharge characteristic of the plasma display panel. During the erase period, an erase ramp waveform (Ramp-ers) having a small pulse width and a low voltage level may be supplied to the sustain electrode or the scan electrode, thereby making it possible to erase the remaining wall charges within all the cells.

<Second, Third, Fourth, . . . Subfields>

Since a driving method performed during a reset period and a sustain period of each of second, third, fourth, . . . subfields SF2, SF3, SF4, . . . is the same as the driving method performed during the reset period and the sustain period of the first subfield, a description thereof is omitted.

In the same way as the first subfield, during an address period of each of the second, third, fourth, . . . subfields SF2, SF3, SF4, . . . , a scan pulse Sp is not supplied to all the scan electrode lines Y1 to Yn, and the scan pulse Sp is supplied to a portion of all the scan electrode lines Y1 to Yn. For example, a scan pulse Sp may be supplied to the odd-numbered scan electrode lines Y1, Y3, Y5, . . . of all the scan electrode lines Y1 to Yn. Otherwise, the scan pulse Sp may be supplied to the even-numbered scan electrode lines Y2, Y4, Y6, . . . of all scan electrode lines Y1 to Yn.

Preferably, during an address period of each of odd-numbered subfields, a scan pulse is supplied to either odd-numbered scan electrode lines or even-numbered scan electrode lines. Then, during an address period of each of even-numbered subfields, a scan pulse is supplied to the scan electrode lines to which the scan pulse is not supplied during the address period of each of the odd-numbered subfields.

Although it is not illustrated in the drawings, during the address period of each of the second, third, fourth, . . . subfields SF2, SF3, SF4, . . . , the scan pulse may be supplied to all the scan electrode lines. This prevents a reduction in image quality capable of being caused by the PLA method. In other words, the scan pulse is supplied to a portion of all the scan electrode lines during the address period of the first subfield, and the scan pulse is supplied to all the scan electrode lines during the address period of each of the remaining subfields. At this time, a subfield, in which the scan pulse is supplied to a portion of all the scan electrode lines, is not limited to the first subfield. Further, the number of selected subfields may be set to a predetermined number.
Further, a subfield, in which the scan pulse is supplied to a portion of all the scan electrode lines, may be selected in accordance with gray level weight.

For example, while the scan pulse may be supplied to a portion of all the scan electrode lines in a subfield with low gray level weight, the scan pulse may be supplied to all the scan electrode lines in a subfield with high gray level weight.

In such a case, the scan pulse may be supplied to either all the scan electrode lines or a portion of all the scan electrode lines in a subfield selected in accordance with specific critical gray level weight.

The critical gray level weight may depend on the brightness or a gray level characteristic of the plasma display panel. However, it is preferable that when all subfields are arranged in increasing order of gray level weight, a subfield with the critical gray level weight is a third subfield in consideration of image quality of an image displayed on the plasma display panel.

In other words, the scan pulse may be supplied to a portion of all the scan electrode lines during an address period of each of three low gray level subfields, and then, the scan pulse may be supplied to all the scan electrode lines during an address period of each of the remaining subfields.

Since the structure of a plasma display apparatus according to a second embodiment of the present invention is the same as the structure of a plasma display apparatus according to the first embodiment of the present invention, a description thereof is omitted. In the plasma display apparatus according to the second embodiment of the present invention, all scan electrodes are divided into a predetermined number of scan electrode groups, and a scan driver supplies a scan pulse to a portion of all the scan electrode groups during an address period.

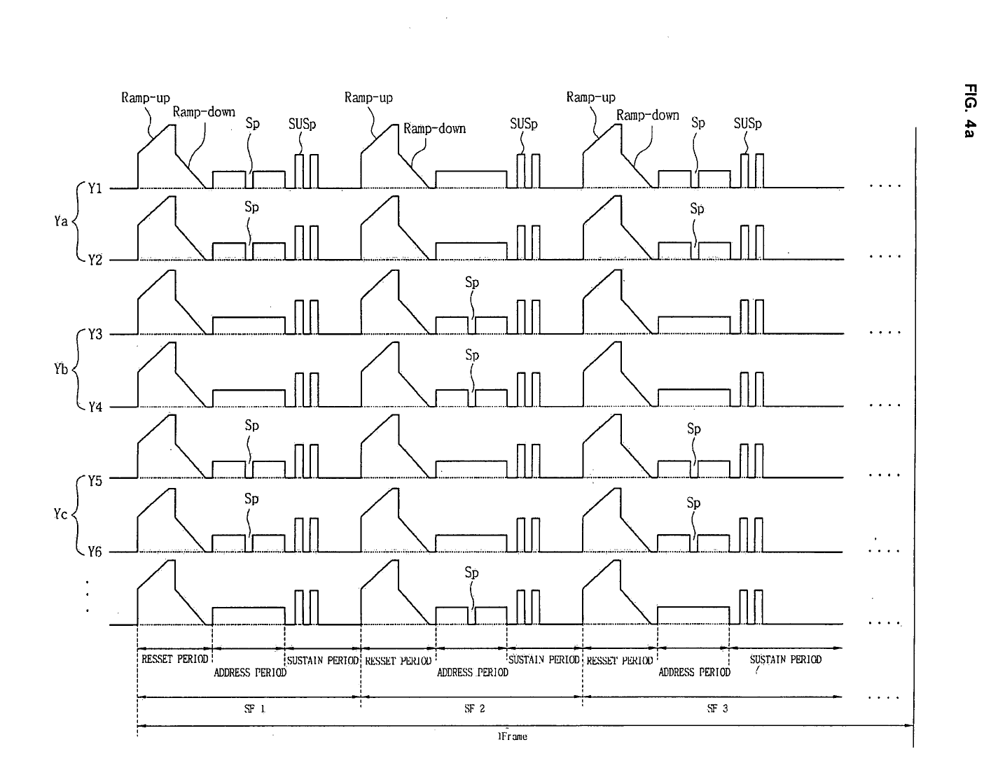

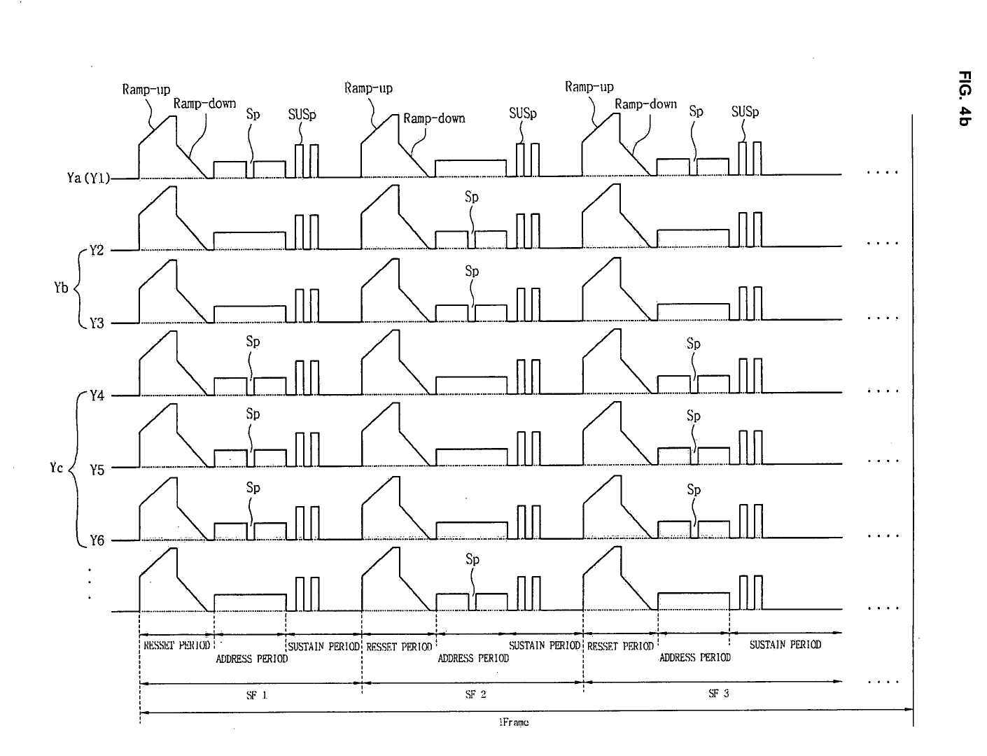

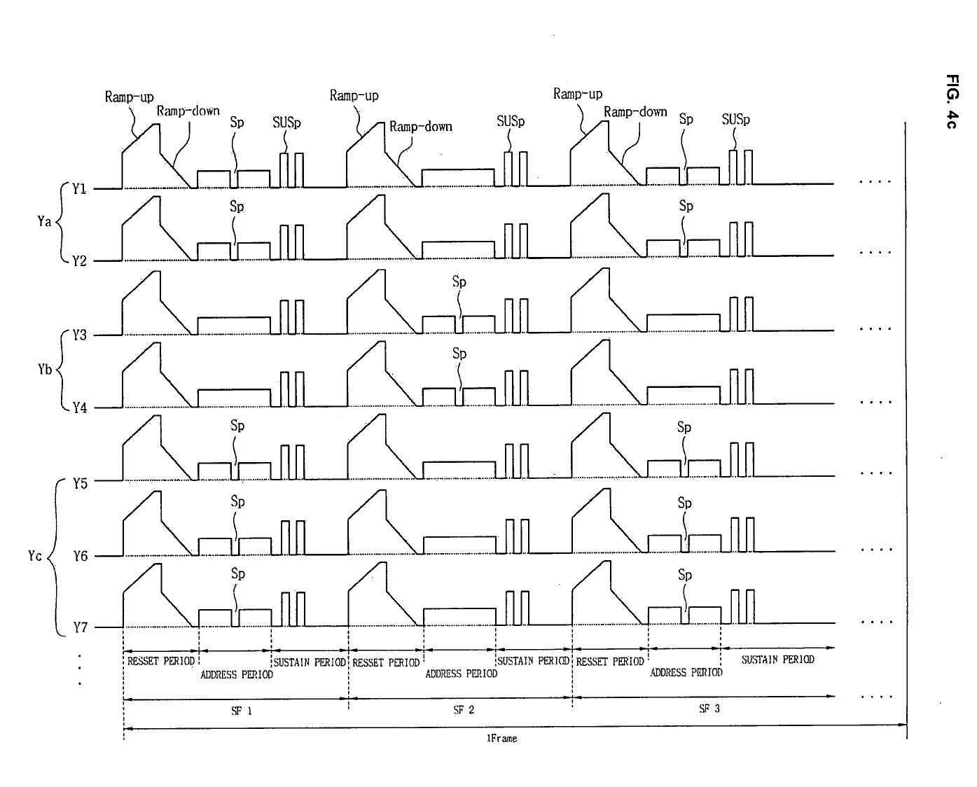

FIGS. 4a to 4c illustrate a scanning method of a scan driver of a plasma display apparatus according to a second embodiment of the present invention.

As illustrated in FIGS. 4a to 4c, when all the scan electrodes are divided into a predetermined number of scan electrode groups, the number of scan electrode groups is equal to at least two. Preferably, the number of scan electrode groups is equal to one half or one third of all the scan electrodes. The number of scan electrodes belonging to each of all the scan electrode groups may be equal to one another as illustrated in FIG. 4a, or may be different from one another as illustrated in FIG. 4b. Further, as illustrated in FIG. 4c, the number of scan electrodes belonging to a portion of all the scan electrode groups may be equal to one another, and the number of scan electrodes belonging to the remaining scan electrode groups may be different from one another. In other words, the number of scan electrodes belonging to at least one of all the scan electrode groups is different from the number of scan electrodes belonging to the remaining scan electrode groups.

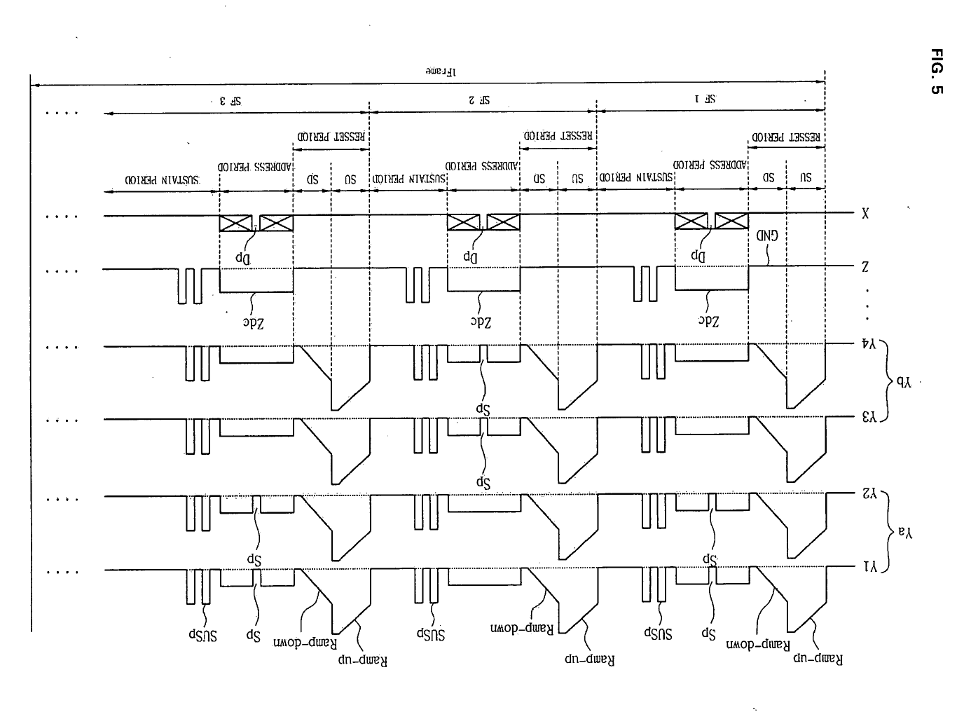

FIG. 5 illustrates a method of driving the plasma display apparatus according to the second embodiment of the present invention.

Referring to FIG. 5, the plasma display apparatus according to the second embodiment of the present invention, in the same way as the first embodiment, is driven by dividing a frame into a plurality of subfields SF1, SF2, SF3, . . . . Each subfield is divided into a reset period, an address period and a sustain period. The driving method of the plasma display apparatus according to the second embodiment of the present invention in each subfield will be described in detail.

<First Subfield>

Since a driving method performed during a reset period and a sustain period of a first subfield SF1 according to the second embodiment of the present invention is the same as the driving method performed during the reset period and the sustain period of the first subfield according to the first embodiment of the present invention, a description thereof is omitted.

All the scan electrodes are divided into a predetermined number of scan electrode groups, and a scan pulse is supplied to a portion of all the scan electrode groups during an address period. More specifically, during an address period, a scan pulse Sp is supplied to either odd-numbered scan electrode groups Ya, Yc, Ye, . . . or even-numbered scan electrode groups Yb, Yd, Yf, . . . of all the scan electrode groups. At this time, a data pulse Dp synchronized with the scan pulse Sp is supplied to address electrodes X. As the voltage difference between the scan pulse Sp and the data pulse Dp is added to the wall voltage generated during the reset period, an address discharge is generated within discharge cells to which the data pulse is supplied.

Further, in the same way as the first embodiment, a given voltage (for example, a ground level voltage) less than a positive voltage Zdc is supplied to sustain electrodes Z during a set-down period, and the positive voltage Zdc is supplied to the sustain electrodes Z during the address period.

<Second, Third, Fourth, . . . Subfields>

Since a driving method performed during a reset period and a sustain period of each of second, third, fourth, . . . subfields SF2, SF3, SF4, . . . according to the second embodiment of the present invention is the same as the driving method performed during the reset period and the sustain period of the first subfield according to the first embodiment of the present invention, a description thereof is omitted.

In the same way as the first subfield, during an address period of each of the second, third, fourth, . . . subfields SF2, SF3, SF4, . . . , a scan pulse Sp is not supplied to all the scan electrode groups, and the scan pulse Sp is supplied to a portion of all the scan electrode groups. For example, a scan pulse Sp is supplied to either the odd-numbered scan electrode groups Ya, Yc, Ye, . . . or the even-numbered scan electrode groups Yb, Yd, Yf, . . . of all the scan electrode groups.

Preferably, during an address period of each of odd-numbered subfields, a scan pulse is supplied to either odd-numbered scan electrode groups or even-numbered scan electrode groups. Then, during an address period of each of even-numbered subfields, a scan pulse is supplied to the scan electrode groups to which the scan pulse is not supplied during the address period of each of the odd-numbered subfields.

In the same way as the first embodiment, during the address period of each of the second, third, fourth, . . . subfields SF2, SF3, SF4, . . . , the scan pulse may be supplied to all the scan electrode groups. This prevents a reduction in image quality capable of being caused by the PLA method. In other words, the scan pulse is supplied to a portion of all the scan electrode groups during the address period of the first subfield, and the scan pulse is supplied to all the scan electrode groups during the address period of each of the remaining subfields. At this time, a subfield, in which the scan pulse is supplied to a portion of all the scan electrode groups, is not limited to the first subfield. Further, the number of selected subfields may be set to a predetermined number.

Further, a subfield, in which the scan pulse is supplied to a portion of all the scan electrode groups, may be selected in accordance with gray level weight. Since this was described in detail in the first embodiment of the present invention, a description thereof is omitted.

As described above, the plasma display apparatus according to the embodiments of the present invention employs a single scanning method, which is more effective than a dual scanning method, to reduce the addressing time. The single scanning method performs an addressing operation using a single data driver, and the dual scanning method performs an addressing operation on the plasma display panel divided into two regions using two data drivers. Further, since the plasma display panel is not divided in the single scanning method, the number of drivers required to drive the plasma display panel in the single scanning method is less than the number of drivers required to drive the plasma display panel in the dual scanning method. Accordingly, the manufacturing cost is reduced.

Further, since the driving method of the plasma display apparatus according to the embodiments of the present invention reduces the addressing time, the duration of the sustain period lengthens such that the brightness of the plasma display apparatus is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of driving a plasma display apparatus, which is driven by dividing a frame into a plurality of subfields, comprising:
scanning a portion of all scan electrodes during an address period of at least one subfield of the plurality of subfields.

2. The method of claim 1, wherein all the scan electrodes are divided into a predetermined number of scan electrode groups, and a portion of the predetermined number of scan electrode groups are scanned.

3. The method of claim 2, wherein the predetermined number of the scan electrode groups is equal to or more than two.

4. The method of claim 2, wherein the number of scan electrodes belonging to each of the predetermined number of scan electrode groups is equal to one another.

5. The method of claim 4, wherein the number of scan electrodes belonging to each of the predetermined number of scan electrode groups is equal to two or three.

6. The method of claim 2, wherein the number of scan electrodes belonging to at least one of the predetermined number of scan electrode groups is different from the number of scan electrodes belonging to the remaining scan electrode groups.

7. The method of claim 1, wherein either odd-numbered scan electrodes or even-numbered scan electrodes of all the scan electrodes are scanned.

8. The method of claim 1, wherein at least one subfield of the plurality of subfields is a subfield with gray level weight equal to or less than critical gray level weight.

9. The method of claim 8, wherein the subfield with gray level weight equal to or less than the critical gray level weight comprises three low gray level subfields.

10. A method of driving a plasma display apparatus, which is driven by dividing a frame into a plurality of subfields, comprising:
scanning either odd-numbered scan electrodes or even-numbered scan electrodes of all scan electrodes during an address period of each of odd-numbered subfields of the plurality of subfields; and
scanning scan electrodes different from the scan electrodes, that are scanned during the address period of each of the odd-numbered subfields, during an address period of each of even-numbered subfields of the plurality of subfields.

11. A plasma display apparatus comprising:
a plasma display panel comprising a plurality of scan electrodes;
a scan driver for supplying a scan pulse to the plurality of scan electrode; and
a timing controller for controlling the scan driver to supply the scan pulse to a portion of the plurality of scan electrode during an address period of at least one subfield of a plurality of subfields.

12. The plasma display apparatus of claim 11, wherein the plurality of scan electrodes are divided into a predetermined number of scan electrode groups, and a portion of the predetermined number of scan electrode groups are scanned.

13. The plasma display apparatus of claim 12, wherein the predetermined number of the scan electrode groups is equal to or more than two.

14. The plasma display apparatus of claim 12, wherein the number of scan electrodes belonging to each of the predetermined number of scan electrode groups is equal to one another.

15. The plasma display apparatus of claim 14, wherein the number of scan electrodes belonging to each of the predetermined number of scan electrode groups is equal to two or three.

16. The plasma display apparatus of claim 12, wherein the number of scan electrodes belonging to at least one of the predetermined number of scan electrode groups is different from the number of scan electrodes belonging to the remaining scan electrode groups.

17. The plasma display apparatus of claim 11, wherein either odd-numbered scan electrodes or even-numbered scan electrodes of the plurality of scan electrodes are scanned.

18. The plasma display apparatus of claim 11, wherein at least one subfield of the plurality of subfields is a subfield with gray level weight equal to or less than critical gray level weight.

19. The plasma display apparatus of claim 18, wherein the subfield with gray level weight equal to or less than the critical gray level weight comprises three low gray level subfields.
